(19) United States
(12) Patent Application Publication
(10) Pub. No.: US 2007/0036296 A1
(43) Pub. Date: Feb. 15, 2007

(54) Methods and systems for securely providing and retaining phone numbers

(75) Inventors: Thomas Francis Flanagan, Springfield, VA (US); William Emil Witowsky, Potomac, MD (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/187,306

(22) Filed: Jul. 22, 2005

(51) Int. Cl. H04M 1/64

(52) U.S. Cl. 379/88.19

(57) ABSTRACT

Methods and systems are provided for securely providing and retaining phone numbers. A party name is provided and an associated phone number, which is encrypted employing an encryption algorithm. The party name is added to an electronic phone list, while the associated telephone number is retained in an encrypted state. A user can select the caller name from the electronic phone list for placing a call. The associated phone number is then decrypted, and the call made employing the decrypted phone number. The decrypted version of the phone number can then be removed or erased from memory. Therefore, the decrypted version of the telephone number is not available for viewing by the user or accessible to an undesirable party that may acquire access to the electronic phone list.

### TECHNICAL FIELD

The present invention relates generally to communications, and more particularly to methods and systems for securely providing and retaining phone numbers.

### BACKGROUND

The classic technique for providing a phone number is for a first party to provide a second party with the phone number of the first party. This can be accomplished verbally, such that the second party enters the phone number of the first party in a phone list or phone book that maintains a party's name and associated phone number or numbers. Recently, phone numbers can be entered into an electronic phone list retained in a party's telephone, cellular phone, video phone, computer or satellite phone. Therefore, a first party providing a phone number to a second party is subjected to security issues in which an undesirable party can access the electronic phone list of the second party by reviewing the second party's electronic phone list, for example, in the event the phone is accessible, lost or stolen. Additionally, security issues can occur as a result of an undesirable party hacking into the electronic phone list to obtain the first party's name and phone number.

Recent advances in phone features allow the first party to electronically transmit the phone number to the second party. For example, many phone users subscribe to a “Caller ID” feature where, during the ringing interval, the recipient of the call is shown the phone number and name of the caller. Therefore, if the recipient is not available to answer a call, the caller's phone number and name are retained in a received call list, such that the caller can select the phone number at a later time to return the call. This again has security issues such that the caller may not want the recipient to retain the caller's phone number. Additionally, an undesirable party may access the received call list and gain access to the caller's phone number and name. Therefore, another feature is available in which a user can choose to have their phone number remain private, in which a recipient does not have access to the caller's phone number or name in the call received list. However, an issue still exists in which a first party wishes for a second party to call the first party without retaining the first party's phone number in an electronic list.

### SUMMARY

In one aspect of the invention, a method is provided for securely providing and retaining phone numbers. The method comprises encrypting a phone number associated with a party, and adding the encrypted phone number and party name associated with the party to an electronic phone list.

In another aspect of the present invention, a telecommunication system is provided having a first telecommunication unit with an electronic phone list and a second first telecommunication unit having an associated party name and associated phone number. The second telecommunication unit provides the first telecommunication unit with the associated party name and an encrypted version of the associated phone number. The first telecommunication unit adds the associated party name and encrypted version of the associated phone number to the electronic phone list.

In yet another aspect of the present invention, a telecommunication unit is provided. The telecommunication unit comprises an encryption and decryption component operative to encrypt and decrypt phone numbers associated with respective party names and a process controller. The process controller is operative to add a received party name and associated encrypted phone number to an electronic phone list and employ the encryption and decryption component to decrypt the encrypted phone number in response to a selection of the associated party name from the electronic phone list, place a call to the associated phone number and erase the decrypted version of the associated phone number from memory.

### BRIEF DESCRIPTION OF THE DRAWINGS

FIG. 1 illustrates a block diagram of a telecommunication system in accordance with an aspect of the present invention.

FIG. 2 illustrates a block diagram of a telecommunication unit in accordance with an aspect of the present invention.

FIG. 3 illustrates an exemplary electronic phone list at a first time period in accordance with an aspect of the present invention.

FIG. 4 illustrates an exemplary electronic phone list at a second time period in accordance with an aspect of the present invention.

FIG. 5 illustrates an exemplary message in accordance with an aspect of the present invention.

FIG. 6 illustrates a methodology for securely providing and retaining phone numbers in accordance with an aspect of the present invention.

FIG. 7 illustrates another methodology for securely providing and retaining phone numbers in accordance with an aspect of the present invention.

### DETAILED DESCRIPTION

Methods and systems are provided for securely providing and retaining phone numbers. A party name is provided and an associated phone number, which is encrypted employing an encryption algorithm. The party name is added to an electronic phone list, while the associated telephone number is retained in an encrypted state. A user can select the caller name from the electronic phone list for placing a call. The associated phone number is then decrypted, and the call made employing a decrypted version of the phone number. The decrypted version of the phone number can then be removed or erased from memory. Therefore, the decrypted version of the telephone number is not available for viewing by the user or accessible to an undesirable party that may acquire access to the electronic phone list.

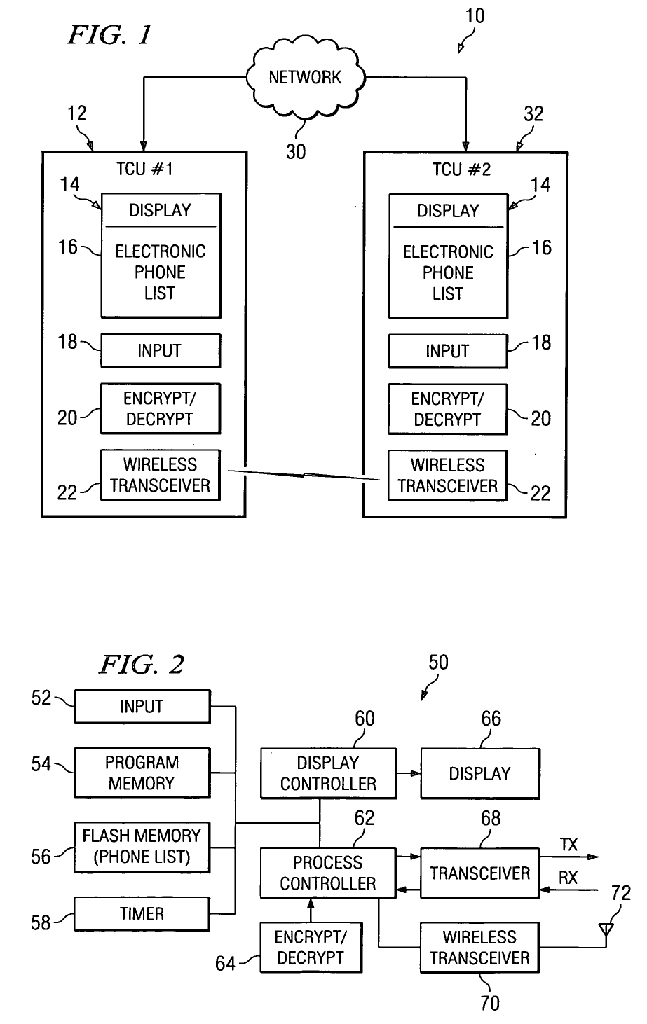

FIG. 1 illustrates a telecommunication system 10 in accordance with an aspect of the present invention. The telecommunication system 10 includes a first telecommunication unit (TCU) 12 that can exchange voice communication with a second TCU 32 via a network 30. The first and second TCUs 12 and 32 can be digital telephones, cellular phones, satellite phones, computer, network or Internet phones, or video phones. The network can be a telephone network such as plain old telephone service (POTS) or public switched telephone network (PSTN), a cellular network, a satellite network, and intranet or the Internet (e.g., Voice Over Internet Protocol (VoIP), Internet Protocol (IP) telephone) in which voice communications can be exchanged between parties. Both the first TCU 12 and the second TCU 32 include a display 14 that is operative to display an electronic phone list 16 that includes phone numbers and associated party names that can be in the form of an electronic phone book, an electronic calls received list, or an electronic calls dialed list. Both the first TCU 12 and the second TCU 32 also include an input device 18, such as a keypad for allowing a user to manually dial phone numbers, move through one or more selectable menus having selectable functions, and manually inputting phone numbers and party names into electronic phone lists (e.g., electronic phone books).

The first TCU 12 and the second TCU 32 also include an encryption/decryption component or algorithm 20 for encrypting and decrypting phone numbers. The encryption/decryption component or algorithm 20 can employ one of many different cryptographic technqiques, such as a secured hash algorithm (sha-1), public/private key encryption (e.g., Pretty Good Privacy (PGP) techniques, Public Key Cryptography Standard (PKCS)), digital signature algorithms (DSA), secret key encryption techniques (e.g., data encryption standard (DES), International Data Encryption Algorithm (IDEA)) or a combination of these techniques.

The encryption/decryption component 20 can be employed for encrypting phone numbers manually entered into the TCU 12 or 32 by a user via the input device 18. For example, a telephone number can be provided verbally to a user and entered into a user's electronic phone list by the user along with a party's name, in which the user's TCU encrypts the phone number prior to storing in a memory of the user's TCU and adds the party's name to the electronic phone list. This prevents other from accessing the phone number via the electronic phone list if the TCU is lost or stolen or accessed via an electronic link. A user can select the party's name from the electronic phone list for placing a call. The associated phone number is then decrypted by the encryption/decryption algorithm, and the call made employing the decrypted phone number. The decrypted version of the phone number can then be removed or erased from the memory of the calling TCU.

The telephone number can be transmitted over the voice communication network 30 or over a wireless transceiver link 22 (separate from the voice communication network 30) in an encrypted form, such that prevention of the intercepting of the phone numbers by others is facilitated. The wireless transceiver link 22 can be, for example, a short range wireless link, such as a wireless transmission conforming to the Bluetooth standard or IEEE 802.11 standard protocol. The encrypted phone number can be embedded in a message transmitted by the party providing the phone number. The message can include the party's name, which can be an actual name, an alias or a service, a command for adding the party's name to an electronic phone list, and optionally a password protected public key that can be employed by the TCU for decrypting the encrypted phone number. The password can be provided verbally or in a subsequent message to the TCU. The party's name can be displayed in an electronic phone list, such as a calls received phone list or added to the electronic phone book of the TCU. A time limit period can be included in the message specifying a time period in which the recipient can retain the phone number of the party. Alternatively, a subsequent command can be issued by the party to request that the party's phone number be removed from a recipient's electronic phone list, thus allowing the party to control the length of time that the user can call the party via the provided phone number and party's name.

FIG. 2 illustrates an exemplary block diagram of a TCU 50 in accordance with an aspect of the present invention. The TCU 50 includes a process controller 62 that controls the operation of the TCU 50 via instructions in a program memory 54. The process controller 62 can handle the transmision and reception of messages via a transceiver 68. The messages can be in the form of voice messages, text messages (e.g., short message service (SMS)), or packets (e.g., VoIP). The process controller 62 employs an encryption/decryption component or algorithm 64 for encrypting and decrypting phone numbers. For example, the encryption/decryption component or algorithm 64 can be employed for encrypting phone numbers manually entered into the TCU 50 by a user via an input device 52, such that name of the party can be retained in an electronic phone list, while the phone number is unavailable for viewing. Additionally, the encryption/decryption component or algorithm 64 can be employed for encrypting a phone number associated with the TCU 50 for transmitting to a respective party, which the user desires to receive a call. The encryption/decryption component or algorithm 64 can be employed for decrypting phone numbers when selecting a party's name from an electronic phone list for placing a call to the selected party. The decrypted phone number can be retained in program memory 54, while placing the call and removed or erased from program memory 54 after the call has been placed.

The program memory 54 can include read only memory (ROM) for executing programs associated with the operation of the TCU 50 and the automatic encyption and decryption of phone numbers, and random access memory (RAM) for the temporary storage of decrypted phone numbers, communication parameters, public keys and other temporary variables. The TCU 50 also includes a flash memory 56 for retaining electronic phone lists, such as electronic phone books, calls received, calls dialed, and associated variables, such as party's names, phone numbers, encrypted phone numbers, private keys and public keys that do not have associated temporary time periods. The flash memory 56 provides read and write capabilites, while retaining information that is needed in the event of a power down of the TCU 50.

The TCU 50 includes a display controller 60 operative for controlling the displaying of menus and functions on a display 66 based on commands or instructions provided via the input device 52 and the process controller 62. The TCU 50 is operative for displaying electronic phone lists on the display, such as an electronic phone book, a calls received phone list and a calls dialed phone list. The displayed electronic phone lists can include parties' names with associated encrypted phone numbers. The TCU 50 can receive encrypted phone numbers associated with other parties via messages received by the transceiver 68 over a communication network, transmitted wirelessly and received through an antenna 72 via a wireless transceiver 70, or input manually into the input device 52 and encrypted via the encrypt/decrypt component or algorithm 64. The TCU 50 can also provide its encrypted phone number via messages transmitted through the transceiver 68 over a communication network, or transmitted wirelessly through the antenna 72 via the wireless transceiver 70. The TCU 50 also includes a timer 58 that can be employed to set a time period based on an instruction received by a party that the party's number is only to be retained for a specified period of time to allow for a call back within a given time frame. It is to be appreciated that a time of the timer can be stored in memory at a beginning of a specified time period and used with the timer to determine expiration of the specified time period.

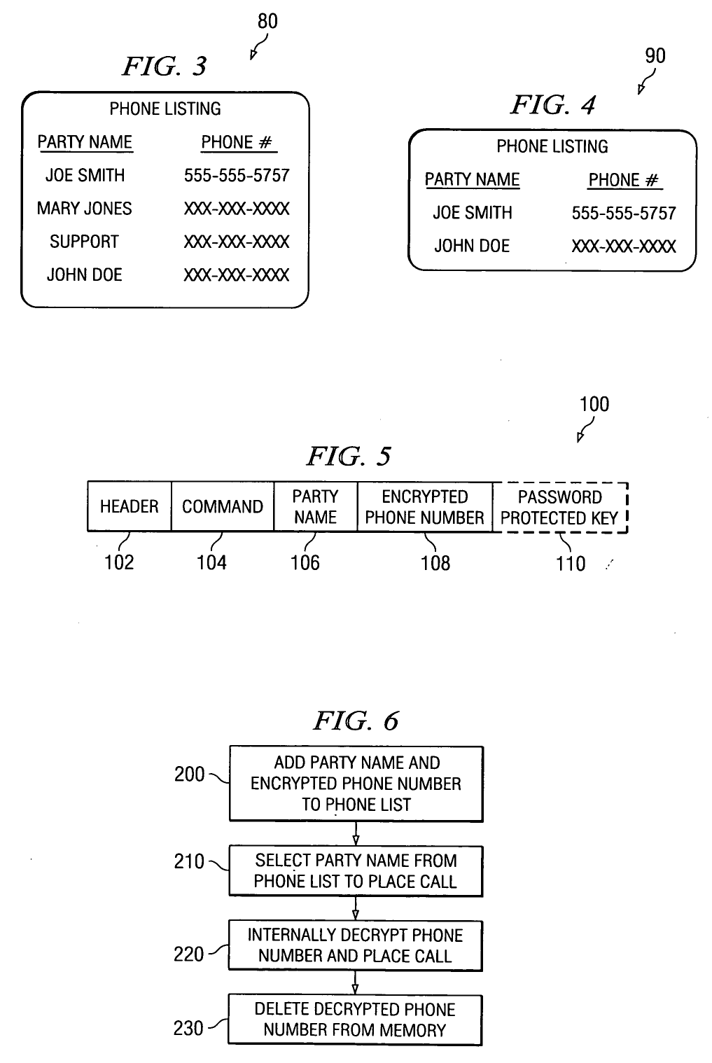

FIG. 3 illustrates an exemplary electronic phone list 80 at a first time period in accordance with an aspect of the present invention. The electronic phone list 80 includes four party entries that include Joe Smith and his associated non-encrypted phone number, Mary Jones and her associated encrypted phone number, a support person and an associated encrypted phone number, and John Doe and his associated encrypted phone number. The support person has provided an encrypted phone number with a specified time limit after which the encrypted phone number will be removed from the electronic phone list 80. In this manner, phone numbers and encrypted phone numbers can be provided for specified periods of time, for example, until a given support issue has been resolved. Mary Jones issues a subsequent command requesting removal of her party name and her associated encrypted phone number. This causes the TCU to remove Mary Jones' name and encrypted phone number from electronic phone list and the TCU. FIG. 4 illustrates an exemplary electronic phone list 90 at a second time period in accordance with an aspect of the present invention. After the first time period has expired, the TCU removes the support name and encrypted phone number from the electronic phone list 80 and the TCU. Between the first time period and the second time period, Mary Jones' name and encrypted phone number is removed from electronic phone list 80 and the TCU in response to Mary Jones issuing a removal request command. The resultant electronic phone list 90 is illustrated in FIG. 4.

FIG. 5 illustrates an exemplary message 100 for transmitting encrypted phone numbers in accordance with an aspect of the present invention. The exemplary message 100 can be in the form of a packet, such as a VoIP packet, a Bluetooth, or IEEE 802.11 packet, a text message, or attached as part of a voice message. The exemplary message 100 includes a header portion 102, a command portion 104, a party name 106, an encrypted phone number 108 and optionally a password protected key portion 110. The header portion 102 can include information associated with the type of message and the attached fields in the message. The command portion 104 can be a command, such as a command for adding the party name and encrypted phone number to an electronic phone list of a recipient. The command can be an add timer command in which a specified time period is attached, such that the party name and encrypted phone number expires at the end of the time period and is removed from the recipient's phone list and TCU at the end of the time period. The command can be a removal request command in which the party name and encrypted phone number is revoked and is removed from the recipient's phone list and TCU at receipt of the removal request command.

The party name 106 can be an entity or service name, an entity's function (e.g., phone support), or a person's name or an alias associated with a person or entity. The encrypted phone number 108 can be encrypted employing one or more of a variety of cryptographic techniques, for example, a secured hash algorithm, public/private key encryption, digital signature algorithms, secret key encryption techniques, etc. The message 100 optionally can include a password protected key portion 110 in which an encrypted public key is provided in the message that can only be opened by the recipient TCU employing an associated password. The encrypted phone number can be encrypted employing an associated private key matching the public key, and decrypted at the recipient TCU employing the public key. The password can be provided to a user of the recipient TCU verbally or in a subsequent message or also encrypted employing an encryption algorithm associated with exchanging passwords.

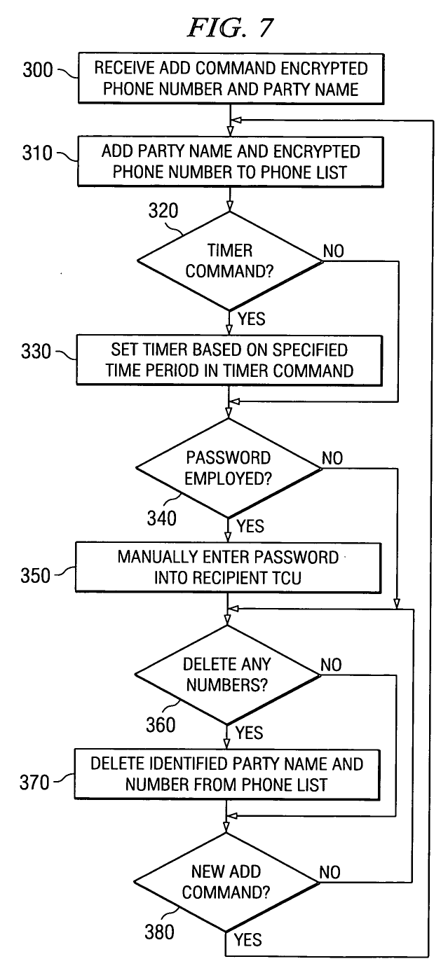

In view of the foregoing structural and functional features described above, a methodology in accordance with various aspects of the present invention will be better appreciated with reference to FIGS. 6-7. While, for purposes of simplicity of explanation, the methodologies of FIGS. 6-7 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 6 illustrates a methodology for securely providing and retaining phone numbers in accordance with an aspect of the present invention. At 200, a party's name and associated encrypted phone number is added to an electronic phone list of a recipient. The phone number can be provided to the recipient with the party's name and added to the electronic phone list via an input device of the recipient's TCU. The phone number can be encrypted by the recipient TCU, such that the phone number is retained in memory in an encrypted format. Alternatively, the encrypted phone number can be received at the recipient TCU in a message along with a party's name. The transmission of the message can occur through a voice message, text message or a wireless link format. The phone number can be encrypted employing one or more of a variety of cryptographic techniques, such as a secured hash algorithm, public/private key encryption, digital signature algorithms, secret key encryption techniques, etc. The methodology then proceeds to 210. At 210, a party name is selected from an electronic phone list of the recipient TCU. At 220, the recipient TCU internally decrypts the encrypted phone number and places the call to the party associated with the party name and encrypted phone number selected from the electronic phone list. At 230, the decrypted version of the phone number is deleted from memory, while the encrypted version is retained.

FIG. 7 illustrates another methodology for securely providing and retaining phone numbers in accordance with an aspect of the present invention. At 300, a recipient TCU receives a message in the form of an add command, an encrypted phone number and a party's name. At 310, the recipient TCU adds the party's name and encrypted phone number to its electronic phone list. At 320, the methodology determines if the command is a add timer command, such that the party's name and encrypted phone number expires after a specified time period. If the command is a timer command (YES), the methodology proceeds to 330 to set a timer of the recipient TCU based on a specified time period in the timer command. The methodology then proceeds to 340. If the command is not a timer command (NO), the methodology proceeds directly to 340.

At 340, the methodology determines if the recipient TCU has received a password protected key, as part of the received message or another received message. If the recipient TCU has received a password protected key (YES), then the password associated with the password protected key is entered into the recipient TCU, for example, manually or through receipt of another message by the recipient TCU. The methodology then proceeds to 360. If the recipient TCU has not received a password protected key (NO), the methodology proceeds directly to 360.

At 360, the methodology determines if any electronic entries are to be deleted from the electronic phone list. For example, an entry may be deleted after a specified time period associated with the entry has expired. Alternatively, an entry may be deleted upon receipt of a removal request command received from a party instructing the recipient TCU to delete the entry. If any electronic entries are to be deleted from the electronic phone list (YES), the methodology proceeds to 370. At 370, the identified party name and phone number is deleted from the electronic phone list. The methodology then proceeds to 380. If electronic entries are not to be deleted from the electronic phone list (NO), the methodology proceeds directly to 380. At 380, the methodology determines if a new add command has been received. If a new add command has not been received (NO), the methodology returns to 360 to determine if any entries are to be deleted. If a new add command has been received (YES), the methodology returns to 310 to add the party's name and encrypted phone number to the electronic phone list of the recipient TCU.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A method for securely providing and retaining phone numbers, the method comprising:
encrypting a phone number associated with a party; and
adding the encrypted phone number and party name associated with the party to an electronic phone list.

2. The method of claim 1, further comprising:
selecting the party name from the electronic phone list;
decrypting the encrypted phone number;
placing a call to the party based on a decrypted version of the phone number; and
deleting the decrypted version of the phone number.

3. The method of claim 1, wherein the encrypting a phone number associated with a party comprises adding the phone number and party name into the electronic phone list of a telecommunication unit (TCU) employing an input device of the telecommunication unit, wherein the TCU automatically encrypts the phone number entered into the electronic phone list.

4. The method of claim 1, further comprising transmitting the encrypted phone number and party name to a recipient telecommunication unit (TCU) in a message.

5. The method of claim 4, wherein the message comprises a command that instructs the recipient TCU to add the encrypted phone number and party name to the electronic phone list of the recipient TCU.

6. The method of claim 5, wherein the command instructs the recipient TCU to add the encrypted phone number and party name to the electronic phone list of the recipient TCU for a specified time period and to remove the encrypted phone number and party name from the electronic phone list and the recipient TCU after the specified time period expires.

7. The method of claim 5, further comprising transmitting a subsequent message that includes a command that instructs the recipient TCU to remove the encrypted phone number and party name from the electronic phone list and the recipient TCU.

8. The method of claim 4, wherein the message comprises a password protected key portion that includes a key for decrypting the encrypted phone number.

9. The method of claim 8, further comprising entering the password into the recipient TCU for unlocking the password protected key portion.

10. The method of claim 4, wherein the message is one of a voice message, a text message and a digitized packet.

11. The method of claim 4, wherein the message is transmitted over a wireless link separate from a communication network link for exchanging voice communications.

12. A telecommunication system comprising:
a first telecommunication unit (TCU) with an electronic phone list;
a second TCU having an associated party name and associated phone number, the second TCU providing the first TCU with the associated party name and an encrypted version of the associated phone number; and
the first TCU adding the associated party name and encrypted version of the associated phone number to the electronic phone list.

13. The system of claim 12, wherein the first TCU is operative to decrypt the encrypted version of the associated phone number in response to a selection of the associated party name from the electronic phone list, place a call to the associated phone number and erase the decrypted version of the associated phone number.

14. The system of claim 12, wherein the second TCU provides the first TCU with the associated party name and an encrypted version of the associated phone number through a message transmitted to the first TCU.

15. The system of claim 14, wherein the message is transmitted over a communication network associated with the first and second TCU.

16. The system of claim 14, wherein the first TCU and second TCU each include a wireless transceiver separate from a communication network for exchanging voice communications between the first TCU and the second TCU, the message being transmitted over the wireless transceivers.

17. The system of claim 14, wherein the message comprises a command that instructs the first TCU to add the encrypted phone number and party name to the electronic phone list.

18. The system of claim 17, wherein the command instructs the first TCU to add the encrypted phone number and party name to the electronic phone list for a specified time period and to remove the encrypted phone number and party name from the electronic phone list after the specified time period expires.

19. The system of claim 14, wherein the second TCU transmits a subsequent message that includes a command that instructs the first TCU to remove the encrypted phone number and party name from the electronic phone list.

20. A telecommunication unit (TCU) comprising:
an encryption and decryption component operative to encrypt and decrypt phone numbers associated with respective party names; and
a process controller being operative to add a received party name and associated encrypted phone number to an electronic phone list and employ the encryption and decryption component to decrypt the encrypted phone number in response to a selection of the associated party name from the electronic phone list, place a call to the associated phone number and erase the decrypted version of the associated phone number from memory.

21. The TCU of claim 20, wherein the process controller is operative to employ the encryption and decryption component to encrypt the phone number associated with the TCU and transmit the encrypted phone number and party name associated with the TCU to another TCU.

22. The TCU of claim 20, wherein the process controller is operative to receive messages from another TCU containing a received party name and associated encrypted phone number for adding to the electronic phone list.

23. The TCU of claim 23, wherein the messages includes a command that instructs the process controller to one of add an encrypted phone number and associated party name to the electronic phone list, add an encrypted phone number and associated party name to the electronic phone list for a specified time period and remove an encrypted phone number and associated party name from the electronic phone list.

24. The TCU of claim 23, wherein the messages are received over one of a transceiver coupleable to a communication network for exchanging voice message with other TCUs and a wireless transceiver link for exchanging encrypted phone numbers separate from a communication network for exchanging voice message with other TCUs.
